(19) United States
(12) Patent Application Publication
(10) Pub. No.: US 2006/0251865 A1
(43) Pub. Date: Nov. 9, 2006

(54) Hollow-chamber profile for utilizing solar energy

(76) Inventor: Horst Hinterneder, Malborn (DE)

Correspondence Address: BAYER MATERIAL SCIENCE LLC, 100 BAYER ROAD, PITTSBURGH, PA, 15205, US

(21) Appl. No.: 10/544,334

(22) PCT Filed: Jan. 7, 2004
(86) PCT No.: PCT/EP04/00034

§ 371 Date: Feb. 2, 2006

(30) Foreign Application Priority Data
Feb. 4, 2003 (DE) 103 04 536.8

(51) Int. Cl. B32B 3/20

(52) U.S. Cl. 428/188

(57) ABSTRACT

A hollow chamber profile section (10, 70) serves for the utilisation of solar energy, in particular for covering absorption rooves or the like, with a transparent upper part (12, 72) and a radiation-absorbing lower part (14), which are jointly produced by two-component extrusion from plastics material and are connected to one another in the interior of the hollow chamber profile section (10, 70) by webs (20, . . . , 30) running in the longitudinal direction, in such a way that parallel flow channels (34, . . . , 48) for a heat transfer medium are formed. The upper part (12, 72) is provided on its outside with a covering layer (50) that is produced jointly with the upper part (12, 72) and the lower part (14) by two-component extrusion combined with co-extrusion from a plastics material that absorbs the ultraviolet component of solar radiation and is transparent to other components.

The invention relates to a hollow chamber profile section for utilising solar energy according to the precharacterising part of claim 1.

Solar collectors in the form of the hollow chamber profile sections mentioned in the introduction provide a possibility for utilising solar radiation. Such a profile construction, which at the same time serves as a structural part for roof coverings and is thus suitable for covering absorption rooves, is illustrated for example in DE 27 49 490. A heat transfer medium, such as for example air, flowing through the profiles absorbs heat from the profile heated by solar radiation and conducts it away through a collector or the like into the building.

In order to create a closed weatherproof roof surface panel-shaped hollow chamber profile sections are arranged adjacent to one another and joined together by groove and tongue joints. The individual profile sections comprise a transparent upper part and a lower, for example black pigmented, part that absorbs the radiation, which are joined to one another by webs running in the longitudinal direction in such a way that parallel flow channels are formed in the interior. The upper part and lower part are produced jointly by two-component extrusion from plastics materials having in each case the desired properties.

The inadequate weathering resistance of the known hollow chamber profile sections has however proved problematical. In particular the transparent upper parts produced from the conventional plastics materials are adversely affected by intense solar radiation and become discoloured and opaque over prolonged use. Furthermore structural damage occurs, as a result of which the requirements in terms of impact strength and resilience can no longer be maintained. In this case there is for example the danger that the profile section could be damaged by hail or by walking on the roof. Since these deleterious effects are caused in particular by the aggressive ultraviolet component of solar radiation, it has already been proposed to provide the outside of the upper part with a UV protective coating. However, such a coating significantly reduces the notch impact strength of the surface.

The object of the present invention is accordingly to provide a hollow chamber profile section of the type mentioned in the introduction that is more resistant to the ultraviolet component of solar radiation and thus has a longer useful life than the known hollow chamber profile sections.

This object is achieved according to the invention by a hollow chamber profile section having the features of claim 1.

The upper part of the hollow chamber profile section according to the invention is provided on its outside with a covering layer consisting of a plastics material that absorbs the ultraviolet component of the radiation and is moreover transparent. This UV-absorbing covering layer is produced jointly with the upper part and the lower part by the combination of two-component extrusion and co-extrusion.

Compared to the conventional UV protective layers, the plastics covering layer can ensure the necessary notch impact strength and blocks the ultraviolet component of solar radiation, so that the transparent upper part of the hollow chamber profile section is permanently protected against aggressive radiation and its optical and mechanical properties are preserved. The upper part thus remains resistant in the long term to discolouration and opaqueness and preserves its mechanical strength. The transparency is moreover not affected, which means that the efficiency of the profile section is maintained. The joint production of the various constituents by two-component extrusion combined with co-extrusion is particularly simple and effective, and at the same time a reliable joining of the superimposed layers is ensured.

In a preferred embodiment at least one thermotropic layer is additionally provided, which either rests on the covering layer or is interposed between the upper part and the covering layer and is produced jointly with the upper part, the lower part and the covering layer by two-component extrusion combined with co-extrusion, from plastics material. The transparency of the thermotropic layer is temperature-dependent. An excessive heating of the interior of the hollow chamber profile section can be prevented by a suitable choice of layer material. If the plastics material of the thermotropic layer is in fact chosen so that it becomes opaque at high temperatures and is thus no longer permeable to solar radiation, an excessive thermal loading of the whole system can be avoided.

In a further preferred embodiment the transparency of the UV-absorbing covering layer itself is temperature-dependent in the manner described above.

Preferably the lower part of the hollow chamber profile section is reinforced by glass fibres. This may be advantageous from various points of view. For example, the inside of the glass fibre-reinforced lower part may have an increased surface roughness, so that a linear flow of the heat transfer medium is disturbed and turbulences are produced, which improve the heat transmission. In this way a higher efficiency of the hollow chamber profile sections is achieved.

Furthermore, the lower part may preferably have a smaller coefficient of thermal expansion than the upper part. Due to the glass fibre reinforcement the thermal expansion of the lower part can be matched to that of the upper part, so that both parts of the hollow chamber profile section have the same thermal expansion despite being at different temperatures, and warpage and leakages cannot occur when the roof surface becomes hot.

In a further preferred embodiment an insulating layer spaced from the lower side of the upper part is arranged in the interior of the hollow chamber profile section, the insulating layer being produced jointly with the upper part, the lower part, the covering layer as well as with an optionally present thermotropic layer by two-component extrusion in combination with co-extrusion, from plastics material. A thermally insulating air cushion may thus be formed between this insulating layer and the upper part, which is intended to prevent thermal losses and heat being dissipated from the hollow chamber profile section to the outside of the roof.

Furthermore, the webs that join the upper part to the lower part are preferably formed in each case integrally from the upper part and lower part, and more specifically in such a way that the height ratio of the web part originating from the lower part, to the web part originating from the upper part, is between 2:1 and 3:1. Accordingly, not only is the inner, lower wall surface of the hollow chamber profile section absorbent, but also the major part of the webs is absorbent. This construction also allows for a good efficiency if the solar radiation falls at an inclined angle on the hollow chamber profile section, since in this case the radiation can readily be absorbed by the absorbing parts of the webs.

Preferred examples of implementation of the invention are described in more detail hereinafter with the aid of the accompanying drawings, in which

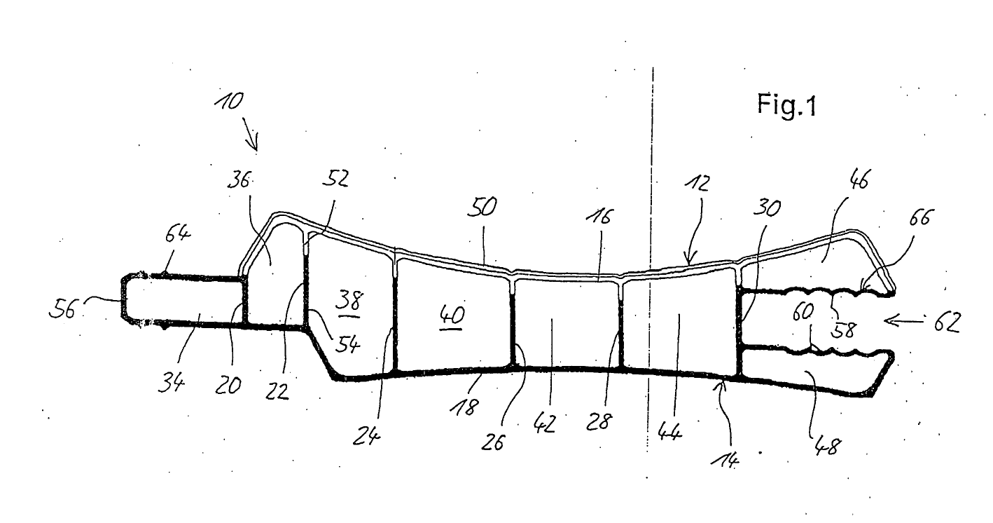

FIG. 1 is a lateral section through a first embodiment of the hollow chamber profile section according to the invention, and

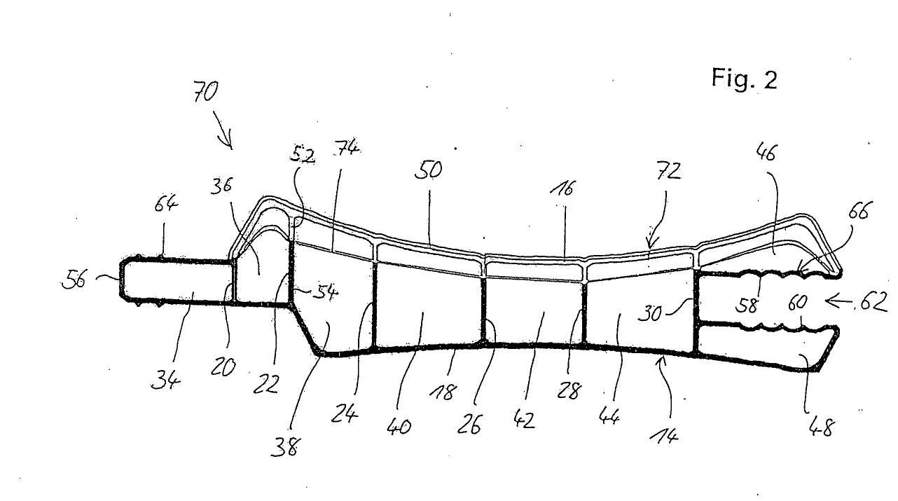

FIG. 2 is a section corresponding to FIG. 1 through a second embodiment of the hollow chamber profile section.

The hollow chamber profile section 10 in FIG. 1 comprises an upper part 12 and a lower part 14 of different plastics materials and is produced by two-component extrusion. The hollow chamber profile section 10 can be joined, in a manner that will be described hereinafter, to further, similar hollow chamber profile sections 10 in such a way that the roof surface of an absorption roof is completely covered so as to absorb solar radiation. In this arrangement the upper part 12 forms the outside of the roof surface, while the inside facing the building to be covered is formed by the lower part 14. The upper part 12 and the lower part 14 lie on top of one another at their respective side edges, so that a hollow space is enclosed in the interior of the hollow chamber profile section 10. The portions of the upper and lower parts 12, 14 that form the outer walls 16, 18 of the hollow chamber profile section 10 are curved concavely with respect to one another, so that the cross-section of the hollow chamber profile section 10 narrows somewhat in its central region.

The hollow space in the interior of the hollow chamber profile section 10 is subdivided by a number of parallel webs 20, 22, 24, 26, 28, 30 running in the longitudinal direction of the profile section 10, into a number of parallel flow channels 34, 36, 38, 40, 42, 44, 46, 48, through which a heat transfer medium (not shown), in particular air, can flow. The flowing heat transfer medium absorbs the heat of the hollow chamber profile section 10, which is heated by the solar radiation, and conveys the heat through a common collecting pipeline or the like (not shown) to the interior of the building.

So that the hollow chamber profile section 10 can perform its function as a solar radiation collector as efficiently as possible, the upper part 12 is manufactured from a plastics material that is transparent to solar radiation, while the lower part 14 absorbs as effectively as possible the radiation that passes through the upper part 12. Both parts 12, 14 may consist of polycarbonate, which in the case of the upper part 12 is transparent, whereas the lower part 12 is pigmented black.

The upper part 12 is provided in its outside, which corresponds to the roof surface, with a covering layer 50 of a plastics material that absorbs the ultraviolet component of the radiation but is transparent to other components. This covering layer 50 prevents the underlying constituents of the hollow chamber profile section 10 being affected in the long term by the aggressive ultraviolet radiation, together with a deterioration in their optical and mechanical properties. In particular it is intended to prevent the upper part 12 becoming opaque or discoloured in the long term, and in addition the fracture strength, impact strength and resilience of the overall construction should be preserved. The efficiency of the hollow chamber profile section 10 is not affected by the covering layer 50. The covering layer 50 is produced jointly with the upper part 12 and the lower part 14 by two-component extrusion combined with co-extrusion, so that a good joining of the individual layers to one another can at the same time be ensured by a production method that is as simple as possible.

It is furthermore possible to apply further layers, which are not shown in FIG. 1, in a similar manner to the upper part 12. In particular thermotropic layers may be provided on the covering layer 50 or between the upper part 12 and the covering layer 50, which are produced jointly with the upper part 12, the lower part 14 and the covering layer 50 by two-component extrusion combined with co-extrusion from plastics materials, and whose transparency alters depending on the temperature. If for example a material that at high temperature becomes impermeable to radiation is chosen for the thermotropic layer, then in this way an overheating of the inner region of the hollow chamber profile section 10 can be prevented. Obviously it is possible for the transparency of the covering layer 50 itself to be temperature-dependent, which avoids the need to add or apply extra thermotropic layers.

The plastics material of which the lower part 14 consists is reinforced by glass fibres and has a roughened surface. A laminar flow through the flow channels 34, . . . , 48 is prevented by the roughening, with the result that turbulences are formed that contribute to the dissipation of heat from the lower part 14 to the heat transfer medium. The efficiency of the hollow chamber profile section 10 is thereby improved. In addition the lower part 14 has due to the glass fibre reinforcement a lower coefficient of thermal expansion than the upper part 12, so that the two parts 12, 14 cannot be distorted if heated by different amounts, and warping, leakages and the like are avoided.

The webs 22, . . . , 30 are in each case composed of a part 52 originating from the upper part 12 and a part 54 originating from the lower part 14. This is illustrated by way of example with the web 22. The web parts 52, 54, originating respectively from the upper part 12 and the lower part 14 are dimensioned so that the web part 54 originating from the lower part 14 is longer than the web part 52 originating from the upper part 12. In the case of the web 22 the length ratio of the lower web part 54 to the upper web part 52 is for example between 2:1 and 3:1. The webs 22, . . . , 30 are thus for the most part absorbent, so that a good efficiency can be achieved even if radiation falls at an angle on the hollow chamber profile section 10.

The lower part 14 finally comprises securement means for forming groove and tongue joints between the individual hollow chamber profile sections 10. At the left-hand edge of the hollow chamber profile section 10 in FIG. 1 the section is closed by an edge connector 56 that is mounted on the web 20 and surrounds the interior of the flow channel 34. At the opposite, right-hand side a groove 62 is surrounded by a part of the web 30 and two chamber walls 58, 60 originating from the latter, into which groove can be inserted a corresponding edge connector 56 of a further hollow chamber profile section 10 (not shown). So that an edge connector 56 can be securely retained in the groove 62, the edge connector 56 has on its oppositely facing surfaces locking teeth 64 that are provided so as to engage in corresponding toothed recesses 66 in the chamber walls 58, 60 of the groove 62. In addition each hollow chamber profile section 10 is provided on its lower part 14 with securement means (not shown) such as clamps or the like, by means of which it can be secured to the building to be covered.

The lower part 14 of the hollow chamber profile section 70 of FIG. 2 is identical to that of the hollow chamber profile section 10 of FIG. 1, so that the description of these details can be omitted at this point. The upper part 72 consists, as in FIG. 1, of transparent plastics material that is covered with a covering layer 50 impermeable to UV radiation and likewise consisting of plastics material. Furthermore web parts 52 project on the lower side of the upper part 72, which together with corresponding web parts 54 of the lower part 14 form the webs running in the longitudinal direction in the interior of the hollow chamber profile section 70. Compared to the construction of FIG. 1, the upper part 72 shown here comprises an additional insulating layer 74 of transparent plastics material, which is spaced from the lower side of the upper part 72. This joins the individual web parts 52 to one another and extends over the whole width of the upper part 72. Between the lower side of the upper part 72 and the insulating layer 74 further chambers 76 are thus separated from the flow channels, which contain an air cushion and largely prevent heat being released from the interior of the hollow chamber profile section 70 to the outside atmosphere. The efficiency is thereby improved by the insulating layer 74. The insulating layer can be produced jointly with all the other remaining constituents of the hollow chamber profile, i.e. in particular with the lower part 14, the upper part 74, the covering layer 50 and optionally further thermotropic layers, by combined two-component extrusion with co-extrusion.

Although the examples of implementation described here are particularly suitable for covering absorption rooves, it is conceivable within the scope of the invention to use hollow chamber profiles in a different way as solar radiation collectors, and to design them appropriately.

1. Hollow chamber profile section (10, 70) for utilising solar energy, in particular for covering absorption rooves or the like, with a transparent upper part (12, 72) and a radiation-absorbing lower part (14), which are produced jointly by two-component extrusion from plastics materials and are joined to one another in the interior of the hollow chamber profile section (10, 70) by webs (20, . . . , 30) running in the longitudinal direction in such a way that parallel flow channels (34, . . . , 48) for a heat transfer medium are formed, characterised in that the upper part and the lower part are curved concavely with respect to one another in cross-section and are therefore narrower in the central region, that the upper part (12, 72) is provided on its outside with a covering layer (50) that is produced jointly with the upper part (12, 72) and the lower part (14) by two-component extrusion combined with co-extrusion, from a plastics material that absorbs the ultraviolet component of solar radiation and is transparent to other components, and that the lower part (14) consists of a glass fibre-reinforced plastics material.

2. Hollow chamber profile according to claim 1, characterised in that in addition at least one thermotropic layer is applied to the covering layer or is inserted between the upper part (12, 72) and the covering layer (50), which thermotropic layer is produced jointly with the upper part (12, 72), the lower part (14) and the covering layer (50) by two-component extrusion combined with co-extrusion from plastics material, and whose transparency is temperature-dependent.

3. Hollow chamber profile according to claim 1, characterised in that the transparency of the covering layer (50) itself is temperature-dependent.

4. Hollow chamber profile according to claim 3, characterised in that the lower part (14) has a lower coefficient of thermal expansion than the upper part (12, 72).

5. Hollow chamber profile section according to one of the preceding claims, characterised in that an insulating layer spaced from the lower side of the upper part (72) is arranged in the interior of the hollow chamber profile section, which insulating layer is produced jointly with the upper part (72), the lower part (14), the covering layer (50) as well as with an optionally present thermotropic layer by two-component extrusion combined with co-extrusion, from plastics material.

6. Hollow chamber profile section according to one of the preceding claims, characterised in that the webs (20, . . . , 30) are formed as a constituent part of the upper part (12, 72) and the lower part (14) in such a way that the height ratio of the web part (54) originating from the lower part (14) to the web part (52) originating from the upper part (12, 72) is between 2:1 and 3:1.
